(19) United States
(12) Patent Application Publication
(10) Pub. No.: US 2026/0251066 A1
(43) Pub. Date: Aug. 27, 2026

(54) HOLLOW FAN BLADE WITH SOLID STATE ADDITIVE MANUFACTURED COVER SKIN

(71) Applicant: RTX Corporation, Farmington, CT (US)

(72) Inventors: Tahany El-Wardany, Vernon, CT (US); Sonia Martinez, Port Saint Lucie, FL (US)

(21) Appl. No.: 19/065,752

(22) Filed: Feb. 27, 2025

(51) Int. Cl. F01D 5/14; F01D 5/28

(52) U.S. Cl. CPC F01D 5/147; F01D 5/28; F05D 2230/30; F05D 2300/133; F05D 2300/173; F05D 2300/174

(57) ABSTRACT

A fan blade for a gas turbine engine includes a main body that extends between a leading edge and a trailing edge. The main body includes channels formed into the main body and a plurality of ribs extending between the channels and a ledge. The ledge is formed as an integral part of the main body and is configured to define an outer perimeter the channels. A cover skin is formed on and metallurgically bonded to the main body, including the ledge and the plurality of ribs of the main body using a hybrid additive manufacturing/subtractive manufacturing process. The cover skin is configured to cover the channels and form an aerodynamic surface. The main body and cover skin form an airfoil that extends radially outwardly from a dovetail, which is configured to permit the fan blade to be attached to a fan rotor of the gas turbine engine.

### BACKGROUND

This application relates to a hollow fan blade and, more specifically, to a hollow fan blade having a solid state additive manufactured cover.

Some current and future aircraft gas turbine engines are designed with large fan blades to allow for high bypass ratios that promote fuel-efficient propulsion. Hollow fan blades are used for some engines to reduce the weight of the fan blades. The hollow fan blades can have a number of hollow channels, which may or may not include a light weight filler. A cover skin, which is typically adhesively bonded to a fan blade main body, encloses the hollow fan blade's hollow channels.

### SUMMARY

One aspect of this disclosure is directed to a fan blade for a gas turbine engine that includes a main body that extends between a leading edge and a trailing edge. The main body includes channels formed into the main body and a plurality of ribs extending between the channels and a ledge. The ledge is formed as an integral part of the main body and is configured to define an outer perimeter the channels. A cover skin is formed on and metallurgically bonded to the main body, including the ledge and the plurality of ribs of the main body using a hybrid additive manufacturing/subtractive manufacturing process. The cover skin is configured to cover the channels and form an aerodynamic surface. The main body and cover skin form an airfoil that extends radially outwardly from a dovetail, which is configured to permit the fan blade to be attached to a fan rotor of the gas turbine engine.

Another aspect of this disclosure is directed to a method of making a fan blade for a gas turbine engine that includes providing a main body that extends between a leading edge and a trailing edge. The main body has channels formed into the main body with a plurality of ribs that extend between the channels and a ledge. The ledge is formed as an integral part of the main body and is configured to define an outer perimeter the channels. A cover skin is formed and metallurgically bonded, using a hybrid additive manufacturing/subtractive manufacturing process, to the ledge and the plurality of ribs of the main body. The cover skin is configured to cover the channels and form an aerodynamic surface. The main body and cover skin form an airfoil that extends radially outwardly from a dovetail, which is configured to permit the fan blade to be attached to a fan rotor of the gas turbine engine.

### BRIEF DESCRIPTION OF THE DRAWINGS

FIG. 1A shows an exemplary aircraft gas turbine engine.

FIG. 1B shows a fan blade according to this disclosure.

FIG. 1C is a view of the fan blade of FIG. 1B mounted in a fan rotor.

FIG. 2 is a cross-sectional view along line 2-2 of the fan blade of FIG. 1B.

FIG. 3 is an elevation view of internal structures of a fan blade of this disclosure.

FIG. 4 shows an assembled fan blade of this disclosure with a cover attached.

FIG. 5 is a block diagram of an exemplary computer numerical control (CNC) machine system useful to make a fan blade according to this disclosure.

FIG. 6A is a perspective view of an exemplary spindle attachment useful with the CNC machine system of FIG. 5.

FIG. 6B is a cross-sectional view of the spindle attachment shown in FIG. 6A taken along line B-B in FIG. 6A.

### DETAILED DESCRIPTION

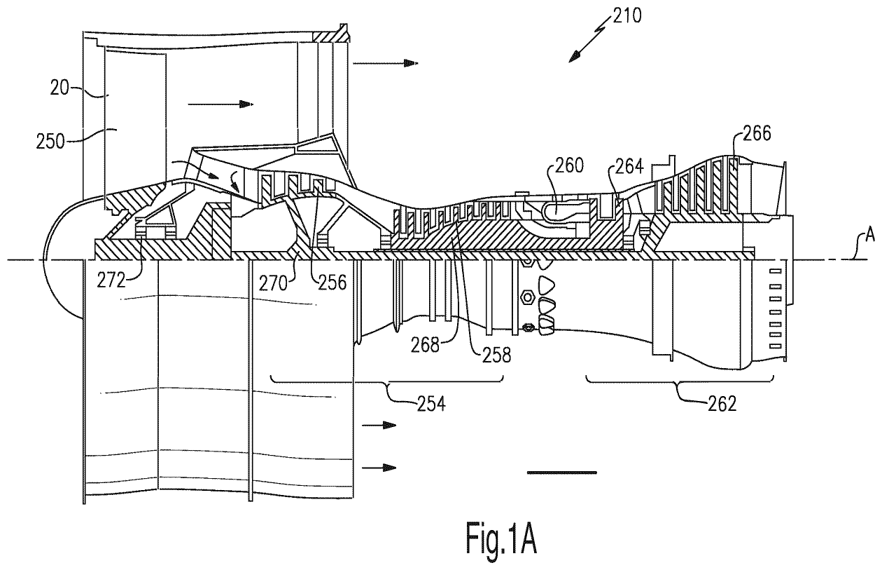

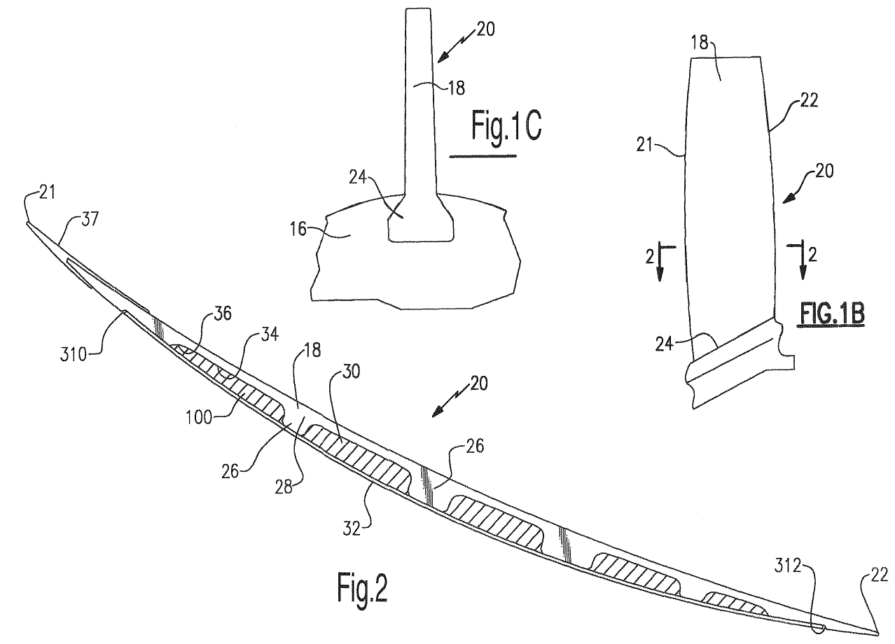

FIG. 1A shows an exemplary aircraft gas turbine engine 210. The engine 210 includes a fan 250 with a plurality of fan blades 20, a compressor section 254 with a low pressure compressor 256 and a high pressure compressor 258, a combustor 260, and a turbine section 262 with a high pressure turbine 264 and a low pressure turbine 266. The compressor section 254, combustor 260, and the turbine section 262 form the engine core. The fan 250 pressurizes air, part of which bypasses the engine core to provide thrust to an aircraft to which the engine 210 is installed and the remainder enters the compressor section 254 where it is compressed and delivered into combustor 260. In the combustor 260, fuel mixes with the compressed air and burns to produce combustion products that pass downstream through the turbine section 262. A high pressure turbine 264 rotates to drive the high pressure compressor 258 is via a first spool 268. A low pressure turbine 266 rotates to drive the low pressure compressor 256 via a second spool 270. The low pressure turbine 266 also drives the fan blades 20 of the fan 250 through a reduction gear 272, which is coupled to the second spool 270. Although the gas turbine engine 210 is described in the context of two spools 268, 270 and a reduction gear 272 as shown, this application applies equally to gas turbine engines that do not include a reduction gear, to single spool and three spool engines, with or without reduction gears, and gas turbine engines having alternative configurations.

FIG. 1B shows an exemplary fan blade 20 with an airfoil 18 that extends radially outward from a dovetail 24. The airfoil 18 includes a leading edge 21 and a trailing edge 22 that define the forward and rearward limits of the airfoil 18, respectively. FIG. 1C shows a fan rotor 16 that is configured to receive the dovetail 24 to mount the fan blade 20 with the airfoil 18 extending radially outwardly from the fan rotor 16.

FIG. 2 is a cross-section of the fan blade 20. The leading edge 21 carries a sheath 37 secured to a fan blade main body 28. The sheath 37 is configured to protect the leading edge 21 from damage and maintain a desired aerodynamic profile on the fan blade 20 leading edge 21. A cover skin 32 closes off cavities or channels 30 in the main body 28. The main body 28 and cover skin 32 may be formed of aluminum, aluminum alloys, titanium, titanium alloys, or any other metals or alloys deemed appropriate for a particular application. In some examples, the cover skin 32 can be made of an aluminum matrix composite having an aluminum matrix with silicon carbide particulates or nano-tubes as a reinforcing phase. The sheath 37 is typically formed of a titanium alloy to provide light weight and strength.

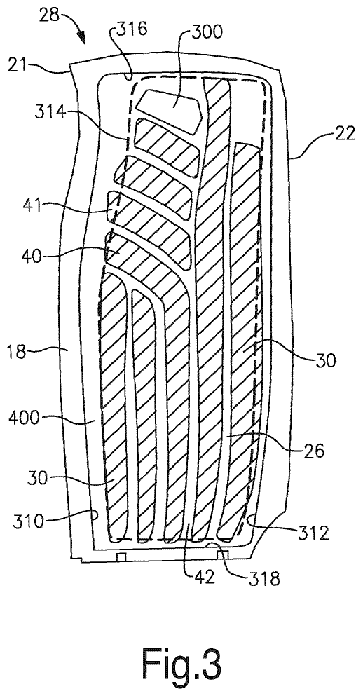

The fan blade 20 includes a plurality of ribs 26 and separate channels 30. In some examples, a filler material 100 may be deposited within the channels 30 to dampen vibrations when the fan blade 20 is in operation. The filler material 100 can be a lighter weight material than the material used to form the main body 28. In one example, the filler material 100 can be an aluminum foam, a titanium foam, an aluminum honeycomb, a titanium honeycomb, or other material deemed to be suitable for a particular application. In another example, a scrim layer 314 (see FIG. 3) of the material used to form the cover 32 (as described further below) can be deposited using friction surfacing additive manufacturing (FSAM) techniques as described further below over the plurality of ribs 26 and separate channels 30 instead of or in addition to the filler material 100. The scrim layer 314 is configured to be a substrate to support formation of the cover 32 on the main body 28.

FIG. 3 is an elevation view of the internal structures of the main body 28 that shows a plurality of channels 30 spaced from the front or leading edge 21 to the back or trailing edge 22. Some of the channels 30 extend generally radially upwardly along the span of the fan blade 20. Other channels, such as channel 40, bend toward the leading edge 21. Channel 41 extends generally from the middle of the main body 28 toward the leading edge 21. In the example depicted in FIG. 3, channel 300 is not filled with filler material 100. Depending on the application, any or all of the channels 30, 40, 41 may be filled or unfilled. A person of ordinary skill will recognize that in other examples, the main body 28 can include a different number of channels 30, 40, 41, and/or channels 30, 40, 41 configured differently than as depicted in FIG. 3. As discussed above, in another example, a scrim layer 314 (shown in dashed lines FIG. 3 to depict that it is optional) can be deposited over the plurality of ribs 26 and separate channels 30, 40, 41 instead of or in addition to the filler material 100.

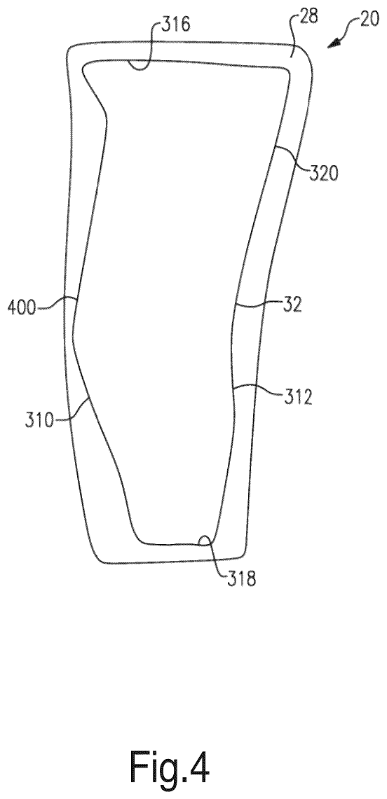

FIG. 3 shows the main body 28 including a ledge 400 defined by ledge edges 310, 312, 316, and 318. Edges 310 and 312 are also shown in FIG. 2 at the leading edge 21 and trailing edge 22 of the fan blade 20. The ledge 400 is formed as an integral part of the main body and is configured to define an outer perimeter of the channels 30, 40, 41 and ribs 26, 42. If used in a particular application, scrim layer 314 is configured to bond to the ledge and optionally to ribs 26, 42 when deposited over the main body 28. As described further below, the cover 32 is configured to bond to the ledge 400, scrim layer 314 (if used), and ribs 26, 42 when the fan blade 20 is finished. FIG. 4 shows a finished fan blade 20 with the cover skin 32 secured to the main body 28 of the fan blade 20.

The cover 32 can be made using a solid-state additive manufacturing (AM) process to deposit a layer of material onto the main body 28 of the fan blade 20 followed by a high-speed machining process to finish the cover skin 32 to the desired dimension, features, and surface finish. As described further below, the cover 32 bonds to the ledge 400 and ribs 26 and is configured to enclose the channels 30, 40, 41 and to provide an aerodynamic surface for the fan blade 20 when finished. The solid-state AM process can be a friction surfacing AM (FSAM) process as described in more detail below. The FSAM process is based on the plastic deformation of a metallic consumable rod. In one example, the rod is placed in a tool holder that is attached to a milling machine spindle. Frictional heat between the rod and a substrate (e.g., the main body 28 of the fan blade 20) generates a viscoplastic boundary layer at the rod tip. The pressure and temperature conditions of the FSAM process lead to an interdiffusion process that creates a metallic bond (i.e., metallurgic bonding) between the plasticized material from the rod and the substrate (e.g., the ledge 400 and ribs 26, 42 of the main body 28). The FSAM process can be used to produce desired geometry and microstructural gradients in the deposited layer (e.g., the cover skin 32) as a function of rotating speed, rod linear feed and applied normal load. The deposited layer (e.g., the cover skin 32) can be machined after deposition using another tool holder in the same tooling magazine of the milling machine. The result is a hybrid additive/subtractive (machining) process that creates, secures, and finishes the cover skin 32 on the main body 28 to form a finished fan blade 20. Appropriate selection of materials, FSAM deposition parameters, and machining parameters enables the manufacture of a substantially defect-free finished fan blade 20 with controlled microstructural gradients and desired mechanical properties, including hardness of the cover skin 32. The interfacial shear strength of the cover skin 32 metallically bonded to the ledge 400 and ribs 26 of the main body 28 is equivalent to or better than the bulk shear strength of the blade that can be obtained with previous adhesive bonding methods.

As discussed above, in some examples, a scrim layer 314 can be formed on the main body before formation of the cover skin 32 as described above and below. The scrim layer 314 can also be formed using a FSAM process as described further below to metallically bond the scrim layer 314 to at least the ledge 400 and optionally to the ribs 26. The scrim layer 314, which can be made from the same material as the cover skin 32, is configured to be a substrate upon which the cover skin 32 is built. In some examples, the scrim layer 314 can be between 0.0127 mm and 2.0 mm thick or any other thickness deemed appropriate for a particular application. Consistent with the further description below, the FSAM process used to form the scrim layer 314 can include one or more deposition path strategies including but not limited to oscillation, zigzag, and contour-based approaches. Depending on the thickness of the scrim layer 314, it may be desirable to provide for uniform cooling and residual stress management after deposition to avoid unwanted distortion.

The FSAM process is controlled to prevent the deposited material from melting so the deposition material does not undergo a phase transformation. This allows the microstructure gradient in the deposit to be controlled as a function of the rotating speed, rod linear feed, and applied normal load used during material deposition. The geometrical tolerance and surface finish of the final product is achieved by milling the deposited surface. The FSAM process can produce substantially porosity-free layers with high interfacial bond strength. In some examples, the FSAM process can deposit>two (2) mm layer thickness on a substrate area of 813 mm×203 mm in twenty-four (24) minutes with a feed rate of 254 mm/min and with a rod diameter of 25.4 mm and possible overlap of 1.27 mm if needed. Using a high-speed machining approach, the spindle speed can be twenty-five thousand (25,000) RPM, five (5) mm axial depth of cut, and a chip load of five tenths (0.05) mm/tooth with a three (3) tooth end mill. The machining time for the different features on the surface is less than twenty (20) minutes.

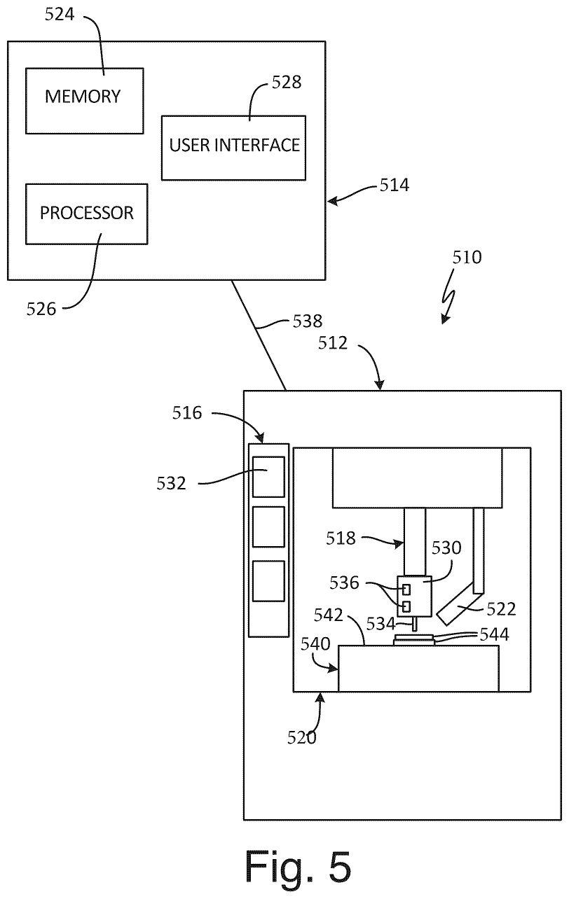

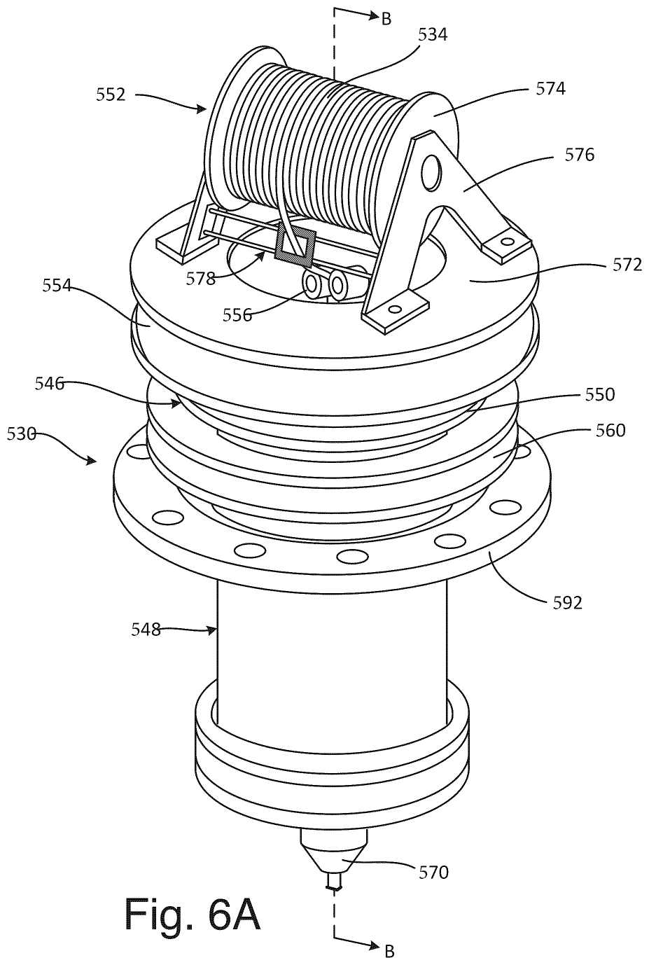

FIG. 5 is a block diagram of exemplary machine system 510 that can be used to implement a FASM process as discussed above. Machine system 510 includes computer numerical control (CNC) machine 512 and computer 514. CNC machine 512 includes tool magazine 516, machine spindle 518, work area 520, and heating element 522. Computer 514 includes memory 524, processor 526, and user interface 528. Tool bank 516 stores subtractive attachments 532 when not in use and can also store additive attachment 530 when not in use. Additive attachment 530 includes wire 534 and sensors 536.

Computer 514 communicates with CNC machine 512 via communication link 538. Communication link 538 can be a wired or wireless connection, and it is understood that computer 514 can be integrated into CNC machine 512 or disposed separately from CNC machine 512. Processor 526, in one example, is a digital logic circuit capable of executing software or other instructions, for example, stored in memory 524.

Memory 524, in some examples, can be configured to store information during operation of computer 514. Memory 524, in some examples, is computer-readable storage media. In some examples, the computer-readable storage media can include a non-transitory medium, and in some examples can include a volatile medium. In some examples, memory 524 is configured to store program instructions for execution by processor 526.

User interface 528, such as a keyboard, touchscreen, monitor, mouse, or other suitable interface device, allows a user to interact with machine system 510, such as by retrieving information from memory 524, receiving notifications, initiating the software stored in memory 524, and inputting additional information to memory 524, among other examples. User interface 528 can also be configured to provide an output of information to the user. For example, user interface 528 can include a sound card, a video graphics card, a speaker, a display device, or other type of device for outputting information in a form understandable to users or machines.

CNC machine 512 is an automated, multi-axis machine tool used to shape workpiece 540 (e.g., cover 32 as deposited onto main body 28) into a desired configuration (e.g., finished fan blade 20). CNC machine 512 can be a 3-axis machine, a 5-axis machine, or any other desired configuration, for example. Workpiece 540 is housed in work area 520, and CNC machine 512 can use additive attachment 530 and subtractive attachments 532 to deposit workpiece 540 and to shape workpiece 540 into the desired configuration. Substrate 542 (e.g., main body 28) is the portion of workpiece 540 onto which layers of material are deposited during the FSAM process.

Tool magazine 516 can store additive attachment 530 and subtractive attachments 532 when not in use. Both additive attachment 530 and subtractive attachments 532 can be connected to and powered by machine spindle 518 and are configured to shape workpiece 540 into the desired configuration. Additive attachment 530 can be configured to add layers 542 of material, such as from wire 534, to substrate 542 through a FSAM process. Sensors 536 can be disposed in or relative to additive attachment 530 and can be configured to sense various operating characteristics of additive attachment 530, such as an applied load, a temperature of wire 534, or any other desired characteristic. Wire 534 can be of any suitable material for applying to substrate 542 through the FSAM process. For example, as discussed above, wire 534 can be aluminum, aluminum alloys, titanium, titanium alloys, or any other metal or alloy deemed appropriate for a particular application. In some examples, the wire can be a hollow wire or rod of aluminum filled with silicon carbide particulates or nano-tubes that will create an aluminum matrix composite when deposited. Wire 534 can be of any desired cross-sectional shape, such as a circle, square, triangle, or any other suitable shape.

Subtractive attachments 532 can remove material from workpiece 540 with any appropriate subtractive manufacturing process, such as through grinding, milling, drilling, or any other substrative manufacturing process deemed appropriate for a particular application. Machine spindle 518 can use both additive attachment 530 and multiple subtractive attachments 532 from tool bank 516, and machine spindle 518 can automatically attach to and detach from both additive attachment 530 and subtractive attachments 532. As such, CNC machine 512 is configured to shape workpiece 540 utilizing various machining attachments and methods.

During an FSAM process, a sacrificial wire or rod of deposition material, such as wire 534 is rotated relative to a substrate, such as substrate 542, and is applied to the substrate with a desired pressure. Friction between the deposition material and the substrate generates heat. The temperature and pressure are controlled, such as by computer 514, to prevent the deposition material from melting and undergoing a phase change. Instead, the heat builds to an FSAM setpoint, which is typically about 70%-90% of the melting point of the deposition material. The FSAM setpoint can be any suitable temperature for plasticizing the deposition material and for providing desired properties at an interface between individual layers, such as layers 544, and at an interface between individual layers and the substrate. Plasticizing the deposition material generates a viscoelastic boundary layer at the tip of the sacrificial wire. The sacrificial wire is then traversed across the substrate and deposits a layer of deposition material on the substrate.

The temperature and pressure conditions during the FSAM process lead to an inter-diffusion process resulting in a metallurgic bond between the plasticized material and the substrate (e.g., the ledge 400 and ribs 26 of the main body 28) to form the cover 32. Because the sacrificial wire does not melt, the sacrificial wire does not undergo a phase transformation and the microstructure gradient of the deposited wire material on the substrate can thus be controlled as a function of the rotational speed, the applied load, and the traverse speed. FSAM thus enables the generation of substantially defect-free parts with high interfacial shear strength and a controlled microstructure gradient that enhances the mechanical hardness of components produced using FSAM. A heating element, such as heating element 522, can be used to preheat the sacrificial wire such that less friction and pressure are required to raise the temperature of the sacrificial wire to the FSAM setpoint.

During operation, information regarding the desired configuration of workpiece 540 is input into computer 514, such as via user interface 528, and can be stored in memory 524. Processor 526 can execute the instructions stored in memory 524 to cause CNC machine 512 to shape the workpiece 540. Workpiece 540 is placed in work area 520 and CNC machine 512 is activated. Computer 514 instructs CNC machine 512 to select additive attachment 530 or subtractive attachments 532 from tool bank 516. CNC machine 512 maneuvers machine spindle 518 and machine spindle 518 attaches to additive attachment 530 or subtractive attachment 532. Machine spindle 518 powers the selected one of additive attachment 530 and subtractive attachments 532 to deposit material and/or shape workpiece 540.

During operation to deposit material onto substrate 542, computer 514 instructs CNC machine 512 to select additive attachment 530. Machine spindle 518 drives the rotation of additive attachment 530 and positions additive attachment 530 relative to substrate 542. Additive attachment 530 is lowered and wire 534 contacts substrate 542. Machine spindle 518 applies a load to additive attachment 530 thereby applying pressure to wire 534 on substrate 542. When the temperature and pressure of wire 534 are at the FSAM setpoint, which can be sensed by sensors 536, machine spindle 518 traverses relative to workpiece 540 to deposit layers 544 of wire 534 material onto substrate 542. Computer 514 controls the rotational speed of additive attachment 530, the load applied, and the traverse speed of machine spindle 518 relative to workpiece 540.

The microstructure of the layers 544 of wire 534 deposited on substrate 542 can be altered by controlling, for example, the rotating speed, the traverse speed, and the applied load. Sensors 536 can provide feedback to computer 514 to allow computer 514 to adjust the operating parameters of machine spindle 518 to thereby control the properties of layers 544. In some examples, sensors 536 can sense the applied load, the heat generated by the FSAM process, the temperature of wire 534, and the pressure on wire 534, among other parameters. Sensors 536 can communicate the information to computer 514 or can use the information to control various internal components within additive attachment 530. The material of wire 534 and the material of substrate 542 can be stored in memory 524 and computer 514 can control additive attachment 530 to provide a desired microstructure. For example, computer 514 can be loaded with instructions that, when executed by processor 526, cause CNC machine 512 to alter the rotating speed, traverse speed, and applied load to produce a boundary layer with the desired material properties in the deposition zone.

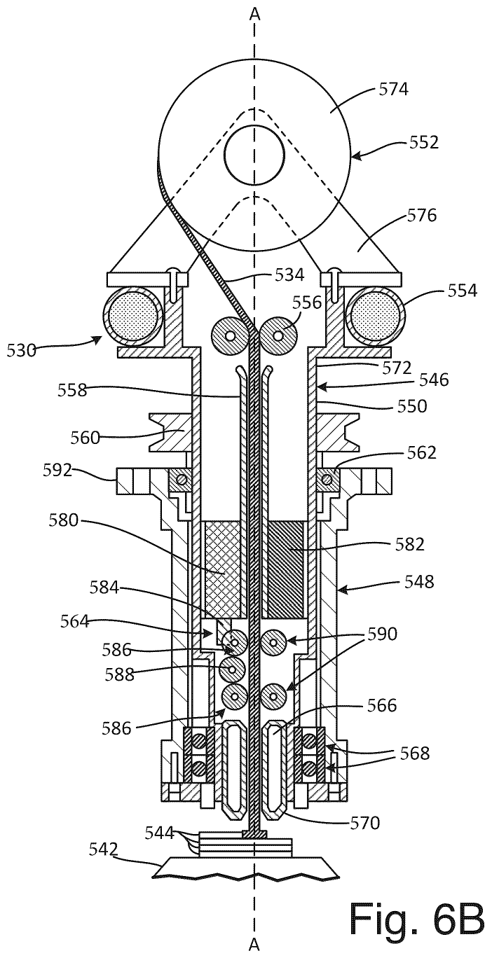

FIG. 6A is a perspective view of additive attachment 530. FIG. 6B is a cross-sectional view of additive attachment 530 taken along line B-B in FIG. 6A. FIGS. 6A and 6B will be discussed together. Additive attachment 530 includes wire 534, rotating assembly 546, and static assembly 548. Rotating assembly 546 includes spindle 550, material supply 552, balance ring 554, guide wheels 556, guide tube 558, drive pulley 560, bearing 562, wire feeder 564, cooling jacket 566, and angular bearings 568. Spindle 550 includes application tip 570 and upper portion 572. Material supply 552 includes reel 574, mount bracket 576, and follower 578. Wire feeder 564 includes motor 580, balance weight 582, transmission gear 584, feeder wheels 586, intermediate gear 588, and idler wheels 590. Static assembly 548 includes mounting flange 592.

Rotating assembly 546 is rotatably mounted on static assembly 548. Mounting flange 592 extends radially from static assembly 548 and can be used to attach additive attachment 530 to a machine for use. Spindle 550 extends through static assembly 548, and application tip 570 projects out of a lower end of static assembly 548. Bearing 562 is disposed between spindle 550 and static assembly 548 and supports rotating assembly 546 for rotation relative to static assembly 548. In some examples, bearing 562 radially supports spindle 550 relative to axis A-A, but it is understood that bearing 562 can provide radial support, axial support, or both. Angular bearings 568 are disposed between spindle 550 and static assembly 548, with angular bearings 568 disposed proximate application tip 570 of spindle 550. Angular bearings 568 can provide both radial and axial support to spindle 550. Balance ring 554 is mounted on spindle 550 below material supply 552 and is configured to absorb vibrations experienced by additive attachment 530, thereby minimizing any adverse effects that can be caused by the vibrations. Drive pulley 560 is mounted on spindle 550 and can receive a device, such as a belt, chain, clamp, or any other suitable device for rotating drive pulley 560 and thus for driving the rotation of rotating assembly 546.

Material supply 552 is mounted on upper portion 572 of spindle 550 outside of static assembly 548. Mount bracket 576 is connected to upper portion 572 of spindle 550, and reel 574 is rotatably supported by mount bracket 576. Similarly, follower 578 is mounted on mount bracket 576, and follower 578 is configured to guide wire 534 between reel 574 and guide wheels 556. Wire 534 wraps around reel 574 and extends from reel 574, through follower 578, and into spindle 550. Wrapping wire 534 on reel 574 provides a feedstock of wire 534 for use throughout the FSAM process, such that the FSAM process does not require stopping and starting to reload additive attachment 530 with additional wire 534. Material supply 552 provides continuous feeding of wire 534 throughout the FSAM process to allow for uninterrupted deposition of layers 544 of wire 534 on substrate 542.

Guide wheels 556 are disposed in upper portion 572 of spindle 550. Guide tube 558 is disposed within spindle 550 and aligned on axis A-A. Guide wheels 556 align wire 534 within spindle 550 as wire 534 enters spindle 550 from material supply 552. Guide tube 558 maintains the alignment of wire 534 within spindle 550 as wire 534 travels between guide wheels 556 and feeder wheels 586.

Wire feeder 564 is disposed within spindle 550 and configured to control the feed of wire 534 through spindle 550. Motor 580 is mounted within spindle 550 and transmission gear 584 is connected to and powered by motor 580. In some examples motor 580 is an electric motor. In some examples, motor 580 is connected to and controlled by computer 514 (shown in FIG. 5). Balance weight 582 is disposed on an opposite side of spindle 550 from motor 580 and is configured to offset a mass of motor 580 to balance spindle 550 during rotation. Transmission gear 584 is connected to and driven by motor 580. Transmission gear 584 meshes with feeder wheels 586 and provides rotational power to feeder wheels 586. Transmission gear 584 can be of any suitable configuration for transmitting power to feeder wheels 586, such as a worm gear, toothed gear, or any other gear deemed suitable for a particular application. While motor 580 is described as providing rotational power through transmission gear 584, it is understood that motor 580 can provide rotational power in any desired manner, such as through a direct connection with one or more feeder wheels 586 or through any desired form of intermediate gear. In some examples, wire feeder 564 includes multiple, intermeshed feeder wheels 586. Where wire feeder 564 includes multiple feeder wheels 586, it is understood that wire feeder 564 can include intermediate gears, such as intermediate gear 588, between feeder wheels 586 to ensure that feeder wheels 586 all rotate in the same direction. Rotating feeder wheels 586 in the same direction allows feeder wheels 586 to exert a downward force on wire 534 to ensure that wire 534 is properly positioned and adequately fed for application throughout any FSAM process. Idler wheels 590 are disposed on an opposite side of wire 534 from feeder wheels 586 and are configured to ensure wire 534 engages feeder wheels 586.

Feeder wheels 586 can engage wire 534 to pull wire 534 through spindle 550 and to resist torquing of wire 534 due to the friction generated between wire 534 and substrate 542. Feeder wheels 586 pull wire 534 from reel 574 and provide wire 534 at tip 570 throughout the FSAM process, thereby ensuring that a continuous supply of wire 534 is available throughout the FSAM process. In some examples, feeder wheels 586 can include teeth to engage wire 534. In some examples, feeder wheels 586 and idler wheels 590 can include intermeshed teeth such that rotation of feeder wheels 586 drives the rotation of idler wheels 590, with wire 534 passing between feeder wheels 586 and idler wheels 590 and engaging a second set of teeth. It is understood, however, that feeder wheels 586 can engage wire 534 in any suitable manner. Feeder wheels 586 engaging wire 534 also provides torque resistance to wire 534 to prevent wire 534 from torquing due to the friction experienced in the FSAM process. Limiting any torquing of wire 534 to the distance between substrate 542 and feeder wheels 586 prevents wire 534 from being damaged by excess torque. Idler wheels 590 maintain the engagement of wire 534 and feeder wheels 586.

Cooling jacket 566 is disposed proximate to tip 570 of spindle 550. After exiting wire feeder 564 wire 534 extends through cooling jacket 566 and exits spindle 550 through tip 570. Cooling jacket 566 can be filled with a cooling substance, such as water, and is positioned to dissipate the heat radiating from wire 534 during the FSAM process. As discussed above, wire 534 is heated to near the melting point of wire 534, such as about 70%-90% of the melting point of wire 534, during the FSAM process. Cooling jacket 566 prevents the heat in wire 534 from radiating into additive attachment 530, which could cause damage to various components of additive attachment 530.

During operation, additive attachment 530 is positioned relative to substrate 542 and spindle 550 is driven to rotate on axis A-A and to apply a layer of wire 534 material on substrate 542. Wire feeder 564 pulls wire 534 from reel 574 and through spindle 550 to position wire 534 outside of tip 570 and into the deposition zone near substrate 542. With spindle 550 rotating on axis A-A, additive attachment 530 is lowered towards substrate 542 and wire 534 is applied to substrate 542 with a desired pressure.

Wire feeder 564 continuously provides additional wire 534 for deposition onto substrate 542. Feeder wheels 586 drive wire 534 towards tip 570 to assist in maintaining the pressure of wire 534 on substrate 542. Feeder wheels 586 pull wire 534 from reel 574 and position the end of wire 534 at tip 570 such that the end of wire 534 is near substrate 542 and positioned to add layers 544 of wire 534 to substrate 542. The feed rate of wire 534 is controlled by motor 580, which supplies rotational power to feeder wheels 586 through transmission gear 584. Transmission gear 584 drives feeder wheels 586, and feeder wheels 586 pull wire 534 from reel 574, through guide wheels 556 and guide tube 558, and push wire 534 out of spindle 550 through tip 570.

The friction and pressure applied to wire 534 cause heat to build at the tip of wire 534. The heat builds until the temperature reaches the FSAM setpoint. Additive attachment 530 traverses substrate 542, and layers 544 of wire 534 are deposited on substrate 542. To generate the heat required to plasticize wire 534 for application during the FSAM process, additive attachment 530 can include a heating element, such as heating element 522 (shown in FIG. 5). The heating element can raise the temperature of wire 534 such that less friction and pressure are required to raise the temperature of wire 534 to the FSAM setpoint. In one example, additive attachment 530 can include an in-situ heating element, such as by conducting electricity through one of feeder wheels 586 or idler wheels 590, to pre-heat wire 534 for application. In some examples, a heating element is disposed outside of additive attachment 530 and focuses energy in the deposition zone to provide additional heat to wire 534. When the temperature of wire 534 reaches the FSAM setpoint, layers 544 can be deposited on substrate 542 through the continued application of pressure and by traversing wire 534 across substrate 542. Layers 544 can be stacked on substrate 542 and can be machined into a final desired form using one or more subtractive attachments 532 as discussed above.

For example, the FSAM process described above can deposit an aluminum, aluminum alloy, titanium, or titanium alloy layer of 1 mm to 4 mm thick to form the cover 32 on the main body 28 using an aluminum, aluminum alloy, titanium, or titanium alloy consumable wire or rod of 25.4 mm diameter using the CNC milling machine 510. The CNC milling marching 510 will continuously feed the wire or rod as it is deposited on the surface of the main body 28. The wire or rod can have a rotational speed of about 3000 RPM and can be fed in an axial direction to apply a normal force of about 890 N at the start of contact with the main body 28. As the process advances the normal forces will be reduced to about 445 N. This load will generate a contact pressure of 2.48 MPa which can be withstand by filler material 100 filling channels 30, 40, 41 in the main body 28. Frictional heat generated at the interface between the wire or rod and the main body 28 forms a viscoplastic boundary layer at the wire or rod tip that results in an interdiffusion process that creates a metallic bond between the plasticized deposition material and the ledge 400 and ribs 26 of the main body 28. The FSAM process can deposit layers that are more than 0.1 mm thick on a substrate area of 813 mm×203 mm in 24 minutes with a feed rate of 254 mm/min and with a step over or an overlap of 1.27 mm between the deposited tracks. Using a high-speed machining approach the deposited layer that forms the cover 32 can be machined to the desired geometrical tolerance and surface finish, for example, with a spindle speed of 24,000 RPM, 1 mm axial depth of cut, and a chip load of 0.05 mm/tooth with 3 teeth end mill. The machining time for the different features on the surface can be less than 24 minutes, resulting in a total production time of 2 to 3 hours, including setup.

This disclosed FSAM method for a cover skin 32 of aluminum or titanium onto a main body 28 provides an number of benefits over the previous process of securing the cover skin 32 to the main body 28 using adhesives, including but not limited to:
Providing a cost-effective, substantially defect-free manufacturing and assembly process for a hollow fan blade 20 cover skin 32 that integrates manufacturing and assembly in a single process, thereby reducing material waste, energy consumption, and production time.
Enhancing material joining capability for the cover skin 32 by enabling joining of dissimilar materials, such as aluminum and other lightweight alloys, with superior strength and precision.
Enhancing microstructural control of the cover skin 32 to improve the mechanical properties (e.g., fatigue and shear strength) compared to previous methods.
Reducing or eliminating the need for post-processing (e.g., machining or finishing) as a result of the FSAM process precision and accuracy during the deposition and bonding.
Integrating advanced cooling/pre-heating techniques during the FSAM process to enhance the quality of the interdiffusion and reduce thermal distortion, which is particularly important for the complex geometries of hollow fan blades 20.
Providing flexibility to deposit a cover skin 32 of either titanium or aluminum alloy cover skin on the filler material 100 filling channels 30, 40, 41 (e.g., an aluminum foam, a titanium foam, an aluminum honeycomb, or a titanium honeycomb) in the main body 28. In some examples, the cover skin 32 can an aluminum matrix composite having an aluminum matrix with silicon carbide particles or nanotubes as a reinforcing phase.

### Discussion of Possible Embodiments

The following are non-exclusive descriptions of possible embodiments of the present invention.

A fan blade for a gas turbine engine includes a main body that extends between a leading edge and a trailing edge. The main body includes channels formed into the main body and a plurality of ribs extending between the channels and a ledge. The ledge is formed as an integral part of the main body and is configured to define an outer perimeter the channels. A cover skin is formed on and metallurgically bonded to the main body, including the ledge and the plurality of ribs of the main body using a hybrid additive manufacturing/subtractive manufacturing process. The cover skin is configured to cover the channels and form an aerodynamic surface. The main body and cover skin form an airfoil that extends radially outwardly from a dovetail, which is configured to permit the fan blade to be attached to a fan rotor of the gas turbine engine.

The fan blade of the preceding paragraph can optionally include, additionally and/or alternatively, any one or more of the following features, configurations and/or additional elements:

At least one of the plurality of channels is filled with a filler material.

The filler material is made from a lighter weight material than the material used to form the main body.

The filler material is an aluminum foam, a titanium foam, an aluminum honeycomb, or a titanium honeycomb

The main body and cover skin are formed from aluminum, an aluminum alloy, titanium, or a titanium alloy.

The cover skin is formed from an aluminum matrix composite having an aluminum matrix with silicon carbide particles or nanotubes as a reinforcing phase

The hybrid additive manufacturing/subtractive manufacturing process includes a friction surfacing additive manufacturing (FSAM) process.

The cover skin is 1 mm to 4 mm thick.

A scrim layer is metallically formed on and metallurgically bonded to the main body before the cover skin is metallically formed on and metallurgically bonded to the main body, wherein the scrim layer is formed on and bonded to the ledge using a hybrid additive manufacturing/subtractive manufacturing process and is configured to be a substrate upon which the cover skin is built.

The scrim layer is aluminum, an aluminum alloy, titanium, or a titanium alloy.

Another aspect of this disclosure is directed to a method of making a fan blade for a gas turbine engine that includes providing a main body that extends between a leading edge and a trailing edge. The main body has channels formed into the main body with a plurality of ribs that extend between the channels and a ledge. The ledge is formed as an integral part of the main body and is configured to define an outer perimeter the channels. A cover skin is formed and metallurgically bonded, using a hybrid additive manufacturing/subtractive manufacturing process, to the ledge and the plurality of ribs of the main body. The cover skin is configured to cover the channels and form an aerodynamic surface. The main body and cover skin form an airfoil that extends radially outwardly from a dovetail, which is configured to permit the fan blade to be attached to a fan rotor of the gas turbine engine.

The method of the preceding paragraph can optionally include, additionally and/or alternatively, any one or more of the following features, configurations and/or additional elements:

Further including machining, using the hybrid additive manufacturing/subtractive manufacturing process, the cover skin after the cover skin is formed and metallically bonded to the main body to provide a desired geometrical tolerance and surface finish to the cover skin.

Further including filling at least one of the plurality of channels with a filler material before the cover skin is formed and metallically bonded to the main body.

The filler material is made from a lighter weight material than the material used to form the main body.

The filler material is an aluminum foam, a titanium foam, an aluminum honeycomb, or a titanium honeycomb

The main body and cover skin are formed from aluminum, an aluminum alloy, titanium, or a titanium alloy.

The cover skin is formed from an aluminum matrix composite having an aluminum matrix with silicon carbide particles or nanotubes as a reinforcing phase

The hybrid additive manufacturing/subtractive manufacturing process includes a friction surfacing additive manufacturing (FSAM) process.

The cover skin is 1 mm to 4 mm thick.

Further comprising forming and metallurgically bonding, using a hybrid additive manufacturing/subtractive manufacturing process, a scrim layer to the main body before the cover skin is metallically formed on and metallurgically bonded to the main body, wherein the scrim layer is configured to be a substrate upon which the cover skin is built.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fan blade for a gas turbine engine comprising:
a main body that extends between a leading edge and a trailing edge, wherein the main body includes channels formed into the main body and a plurality of ribs extending between the channels and a ledge and wherein the ledge is formed as an integral part of the main body and is configured to define an outer perimeter of the channels;
a cover skin metallically formed on and metallurgically bonded to the main body, wherein the cover skin is formed on and bonded to the ledge and the plurality of ribs of the main body using a hybrid additive manufacturing/subtractive manufacturing process and is configured to cover the channels and form an aerodynamic surface;
wherein the main body and cover skin form an airfoil that extends radially outwardly from a dovetail; and
wherein the dovetail is configured to permit the fan blade to be attached to a fan rotor of the gas turbine engine.

2. The airfoil of claim 1, wherein at least one of the plurality of channels is filled with a filler material.

3. The airfoil of claim 2, wherein the filler material is made from a lighter weight material than the material used to form the main body.

4. The airfoil of claim 2, wherein the filler material is an aluminum foam, a titanium foam, an aluminum honeycomb, or a titanium honeycomb

5. The airfoil of claim 1, wherein the main body and cover skin are formed from aluminum, an aluminum alloy, titanium, or a titanium alloy.

6. The airfoil of claim 1, wherein the cover skin is formed from an aluminum matrix composite having an aluminum matrix with silicon carbide particles or nanotubes as a reinforcing phase

7. The airfoil of claim 1, wherein the hybrid additive manufacturing/subtractive manufacturing process includes a friction surfacing additive manufacturing (FSAM) process.

8. The airfoil of claim 1, wherein the cover skin is 1 mm to 4 mm thick.

9. The airfoil of claim 1, wherein a scrim layer is metallically formed on and metallurgically bonded to the main body before the cover skin is metallically formed on and metallurgically bonded to the main body, wherein the scrim layer is formed on and bonded to the ledge using a hybrid additive manufacturing/subtractive manufacturing process and is configured to be a substrate upon which the cover skin is built.

10. The airfoil of claim 9, wherein the scrim layer is aluminum, an aluminum alloy, titanium, or a titanium alloy.

11. A method of making a fan blade for a gas turbine engine comprising:
providing a main body that extends between a leading edge and a trailing edge having channels formed into the main body with a plurality of ribs extending between the channels and a ledge wherein the ledge is formed as an integral part of the main body and is configured to define an outer perimeter the channels;
forming and metallurgically bonding, using a hybrid additive manufacturing/subtractive manufacturing process, a cover skin to the main body, wherein the cover skin is formed on and bonded to the ledge and the plurality of ribs of the main body and is configured to cover the channels and form an aerodynamic surface;
wherein the main body and cover skin form an airfoil that extends radially outwardly from a dovetail; and
wherein the dovetail is configured to permit the fan blade to be attached to a fan rotor of the gas turbine engine.

12. The method of claim 11, further comprising:
machining, using the hybrid additive manufacturing/subtractive manufacturing process, the cover skin after the cover skin is formed and metallically bonded to the main body to provide a desired geometrical tolerance and surface finish to the cover skin.

13. The method of claim 11, further comprising:
filling at least one of the plurality of channels with a filler material before the cover skin is formed and metallically bonded to the main body.

14. The method of claim 13, wherein the filler material is made from a lighter weight material than the material used to form the main body.

15. The method of claim 13, wherein the filler material is an aluminum foam, a titanium foam, an aluminum honeycomb, or a titanium honeycomb

16. The method of claim 11, wherein the main body and cover skin are formed from aluminum, an aluminum alloy, titanium, or a titanium alloy.

17. The method of claim 11, wherein the cover skin is formed from an aluminum matrix composite having an aluminum matrix with silicon carbide particles or nanotubes as a reinforcing phase

18. The method of claim 11, wherein the hybrid additive manufacturing/subtractive manufacturing process includes a friction surfacing additive manufacturing (FSAM) process.

19. The method of claim 11, wherein the cover skin is 1 mm to 4 mm thick.

20. The method of claim 11, further comprising:
forming and metallurgically bonding, using a hybrid additive manufacturing/subtractive manufacturing process, a scrim layer to the main body before the cover skin is metallically formed on and metallurgically bonded to the main body, wherein the scrim layer is configured to be a substrate upon which the cover skin is built.
